(19) United States
(12) Patent Application Publication
(10) Pub. No.: US 2005/0068577 A1
(43) Pub. Date: Mar. 31, 2005

(54) Method for converting image data records in medical imaging

(76) Inventors: Thomas Birkhoelzer, Radolfzel (DE); Frank Krickhahn, Herzogenaurach (DE); Juergen Vaupel, Weisendorf (DE)

Correspondence Address: HARNESS, DICKEY & PIERCE, P.L.C., P.O.BOX 8910, RESTON, VA, 20195, US

(21) Appl. No.: 10/948,292

(22) Filed: Sep. 24, 2004

(30) Foreign Application Priority Data
Sep. 26, 2003 (DE) 10344812.8

(51) Int. Cl. G06F 15/00

(52) U.S. Cl. 358/1.15; 358/1.13

(57) ABSTRACT

A method is for converting image data records in medical imaging. An external service provider connected to a network receives the medical image data in the initial format via the network. He then converts them into the desired target format, and either sends them to the sender and/or to an addressee specified by the latter in the target format, or provides them for retrieval via the network. As such, the user's involvement in converting medical image data records, both in terms of economics and in terms of time, is reduced.

The present application hereby claims priority under 35 U.S.C. §119 on German patent application number DE 103 44 812.8 filed Sep. 26, 2003, the entire contents of each of which are hereby incorporated herein by reference.

### FIELD OF THE INVENTION

The present invention generally relates to a method for converting image data records which are produced in medical imaging and are distributed further from there, possibly to other centers or people.

### BACKGROUND OF THE INVENTION

In medical imaging, physical regularities are exploited to obtain images of the inside of the body of a living examination object. Examples of corresponding imaging systems are computer tomography or magnetic resonance tomography. The image data records for the images are captured in a medical data acquisition center, for example in the radiology department of a hospital, using the appropriate device and are visually displayed, i.e. shown on an appropriate display unit, after conditioning or evaluation of the raw or image data obtained during the measurement.

The image data records produced in medical imaging are available almost exclusively in DICOM format today. DICOM (Digital Imaging and Communications in Medicine) is a specific standard for radiology which applies throughout the world. It was designed on the basis of the OSI model (open system interconnection model), which permits communication between heterogeneous systems. It can be used to interchange images and data from different imaging and image-processing devices between the devices. DICOM standardizes the structure of the formats and descriptive parameters for radiological images and commands for interchanging these images, and also the description of other data objects, such as image sequences, series of examinations and findings.

Recipients of these image data or image data records, such as registered doctors for example, require particular applications on their computer systems in order to view and possibly process the image data records further or forward them. These applications need to be able to read the special medical image data format and possibly to convert it into another image data format if the doctor wishes to incorporate a photograph into an appropriate presentation program, for example for the purpose of a presentation. In addition, it may be necessary to put the image data records received onto another data storage medium format, for example a CD-ROM, a DVD or an MOD. The recipient again needs special hardware and software for this purpose too.

All in all, a plurality of applications are needed in order to convert the data in their respective format to one or more desired target formats. This gives rise to not inconsiderable purchasing and maintenance costs for the software and hardware. In addition, conversion is an operation which may take up the recipient's or his system's time and resources.

### SUMMARY OF THE INVENTION

An object of an embodiment of the present invention is to specify a method for converting image data records in medical imaging which relieves the time and economic burden on the recipient or user of the image data records available in a particular format.

In one embodiment, the present method is for converting image data records in medical imaging. An external service provider, which is connected to a network or can be reached via a network, receives the medical image data records in the initial format via the network. The external service provider then converts these medical image data records from the initial format into the desired target format and sends the converted image data to the sender and/or to one or more addressees specified by the sender. Alternatively, the external service provider may provide the converted image data records for the sender or addressee to retrieve from a server via the network.

In this context, the term conversion is to be understood in the general sense, i.e. meaning that a data input is taken and a data output is produced in a desired format and in a desired form, for example in a desired image data format or on a desired data storage medium. In the case of the embodiments of the present method, the image data records are converted not on a recipient's or user's computer system, but rather by a web-based conversion service. This service provider, which is economically independent in its action, is implemented by a server which has access to different conversion applications and uses their functionality to offer conversion of various initial formats into target formats, particularly different data formats and/or different data storage media. The user sends the data to be converted and information about the initial and target formats to this service provider via the network and obtains the data in the target format in return.

The user thus requires no kind of applications for converting the medical image data records. He needs to purchase neither particular hardware nor particular software and is nevertheless able to perform a wide variety of conversions. Particularly for recipients of medical image data records who need to perform conversions only to a small extent, the embodiments of the present method using the external service provider affords considerable economic advantages.

The user can transfer his data to be converted to the external service provider via the network from a computer with very little involvement in terms of work and time and obtains the desired target formats back either again via the network or, for example when a data storage medium is produced, by mail or courier. It goes without saying that in this context the user requires access to the network.

The network used is preferably a publically accessible network such as the internet, which is used by most potential recipients of medical image data records. When transferring the image data records via the internet, for example using the http protocol or via e-mail, encrypted transfer protocols such as SSL are preferably used. The service provider preferably has a web page which can be used to contact it and to set up the appropriate encrypted connection. Similarly, a “dial-in point-to-point” connection may be used for safe transfer.

The converted image data records may be sent back to the user or sender by e-mail or by way of direct retrieval from an area allocated to him on the service provider's server, for example. In addition, it is naturally possible to send the converted data to one or more other addressees who have been correspondingly specified by the sender. This practice is appropriate, for example, when the medical data acquisition center at which a patient's medical image data have been captured using an appropriate device, for example a computer tomograph, need to be sent in a converted form to a referring doctor who has no way of displaying DICOM-based image formats.

In a further embodiment of the present method, the external service provider has a DICOM interface with an associated address and underlying DICOM services, which means that he can be addressed and can receive the data directly via a DICOM node.

The services of the service provider may be paid for, by way of example, per image data record or dataset or else in the form of a subscription or as part of a service agreement at fixed intervals of time regardless of the number of data records converted. In addition, it is naturally also possible for the services of the service provider to be provided at no cost when advertisements are inserted in corresponding fashion. A hybrid form of the models cited is also suitable.

### BRIEF DESCRIPTION OF THE DRAWINGS

The present invention will become more fully understood from the detailed description of the exemplary embodiments given hereinbelow and the accompanying drawings, which are given by way of illustration only and thus are not limitative of the present invention, and wherein:

FIG. 1 shows an exemplary embodiment.

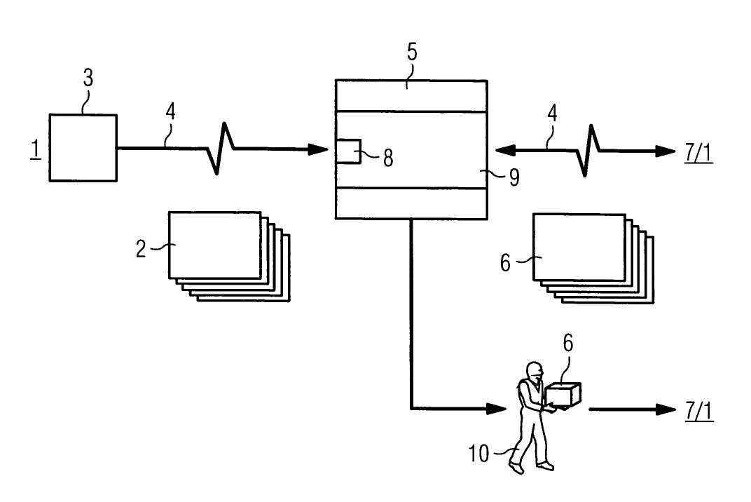

### DETAILED DESCRIPTION OF THE EXEMPLARY EMBODIMENTS

The present method is explained again briefly below using an exemplary embodiment in conjunction with the FIGURE.

In the present example a doctor, as the user 1 of the present method, has image data 2 in DICOM format. He firstly wishes to obtain these image data back in a JPEG format and secondly wishes to send them to a colleague 7 in PDF format on a DVD, since this colleague is able to read the data in this form only. The user 1 is connected to a network 4, in the present case the internet, via a data station 3. He calls up the address of the external service provider 5 in this network 4 and uses the external service provider's web page to set up a secure connection to the external service provider.

Finally, he uses this secure connection to transfer the DICOM image data 2 to be converted to the server 9 of the external service provider 5. For this transfer, he also specifies the desired target formats JPEG and PDF, and indicates that the PDF data need to be burned to DVD and sent to a colleague as further addressee 7.

In this case, the doctor 1 requires neither a conversion program for converting DICOM data into the JPEG format nor a DVD burner or a PDF writer. Rather, he sends the data 2 directly via the network 4 to the external service provider 5. The external service provider firstly converts the received data into the JPEG format and returns them by e-mail to the doctor 1 via the network 4.

Secondly, the external service provider 5 also converts the received image data 2 into a PDF format and burns them to a DVD. The DVD is then sent by courier 10 to the colleague 7 of the doctor 1. The involvement of the doctor 1 for these measures is minimal.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for converting image data records in medical imaging, comprising:
receiving, via a network, the image data records from a sender;
converting the image data records from an initial format to a desired target format; and
at least one of
sending the converted image data records in the target format to at least one of the sender and an addressee specified by the sender, and
providing the converted image data records in the target format for retrieval via the network.

2. The method as claimed in claim 1, wherein the image data records are converted into an image format other than the target format.

3. The method as claimed in claim 1, wherein the image data records are put onto a particular type of data storage medium as the target format.

4. The method as claimed in claim 3, wherein the converted image data records are sent to at least one of the sender and the addressee on the particular type of data storage medium.

5. The method as claimed in claim 1, wherein the converted image data records are sent by e-mail.

6. The method as claimed in claim 1, wherein the image data records are at least one of received and sent via a publically accessible network.

7. The method as claimed in claim 1, wherein the image data records are converted automatically by a server.

8. The method as claimed in claim 1, wherein a DICOM interface is used to receive the image data records via the network by observing the DICOM standard.

9. The method as claimed in claim 2, wherein the image data records are put onto a particular type of data storage medium as the target format.

10. The method as claimed in claim 9, wherein the converted image data records are sent to at least one of the sender and the addressee on the particular type of data storage medium.

11. The method as claimed in claim 2, wherein the converted image data records are sent by e-mail.

12. The method as claimed in claim 6, wherein the image data records are at least one of received and sent via the internet.

13. The method of claim 1, wherein the digital image data records are received by an external service provider.

14. The method as claimed in claim 13, wherein the image data records are converted automatically by a server associated with the external service provider.

15. The method of claim 8, wherein the digital image data records are received by an external service provider.

16. The method as claimed in claim 15, wherein the image data records are converted automatically by a server associated with the external service provider.

17. A method, comprising:
receiving from a sender, via a network, digital image data records;
converting the image data records from an initial format to a target format; and
sending the converted image data records in the target format to at least one of the sender and an addressee specified by the sender.

18. A method, comprising:
receiving from a sender, via a network, digital image data records;
converting the image data records from an initial format to a target format; and
providing the converted image data records in the target format for retrieval via the network.
